(19) United States
(12) Patent Application Publication
(10) Pub. No.: US 2011/0074919 A1
(43) Pub. Date: Mar. 31, 2011

(54) Signal generation apparatus and shutter spectacles

(75) Inventors: Kazunari Yoshifuji, Tokyo (JP); Isao Ohashi, Kanagawa (JP)

(73) Assignee: Sony Corporation, Tokyo (JP)

(21) Appl. No.: 12/805,087

(22) Filed: Jul. 12, 2010

(30) Foreign Application Priority Data
Sep. 25, 2009 (JP) 2009-221299

(51) Int. Cl. H04N 13/04; H04N 13/00

(52) U.S. Cl. 348/43; 348/56; 348/E13.075; 348/E13.073

(57) ABSTRACT

A signal generation apparatus includes: a bit-clock extraction section configured to receive a digital audio signal output by an apparatus for displaying a 2-d video image used for sensing a 3-d stereoscopic video image on a screen determined in advance and to extract a bit clock signal from the digital audio signal; and a timing-signal generation section configured to generate a timing signal having the same period as a vertical synchronization signal of the 2-d video image from the bit clock signal extracted by the bit-clock extraction section.

### BACKGROUND OF THE INVENTION

1. Field of the Invention

In general, the present invention relates to a signal generation apparatus and shutter spectacles for the apparatus. More particularly, the present invention relates to a timing-signal generation apparatus making a display apparatus capable of displaying a 3-d (three-dimensional) stereoscopic video image content to the user even if the display apparatus for displaying the video image content does not have a function to output a timing signal and relates to shutter spectacles for the timing-signal generation apparatus.

2. Description of the Related Art

In recent years, the popularization of a TV receiver having a flat panel display screen has been making progress at a high pace. Typical examples of the flat panel display screen are an LCD (Liquid Crystal Display) screen and a PDP (Plasma Display Panel) screen. In addition, in December 2003, terrestrial digital broadcasting has been started so that video images of high-quality and high-definition broadcasting can be watched also at homes. On top of that, recently, the popularization of the recording/reproduction apparatus for high-vision video images has also been making progress at a high pace so that there is now already provided an environment that allows the user to watch not only video images of high-vision broadcasting but also contents recorded on a package medium as contents each having a high-vision image quality. In such a condition, flat panel display screens are announced one after another as screens which are each capable of displaying 3-d stereoscopic video image contents.

As a method for watching a 3-d stereoscopic video image, there are two large categories, that is, a spectacle method and a naked-eye method. The spectacle method is a method making use of polarization-filter spectacles or shutter spectacles. On the other hand, the naked-eye method is a method not making use of spectacles. Typical examples of the naked-eye method are a lenticular method and a parallax barrier method. For more information on the methods for watching 3-d stereoscopic video images, the reader is advised to refer to documents such as Japanese Patent Laid-Open No. 2006-126501. From the view of compatibility with a 2-d (two-dimensional) video image display screen, rather than the naked-eye method, the spectacle method is expected to become the popular video image watching method adopted in general homes in the near future.

FIG. 1 is a diagram showing the principle of watching 3-d stereoscopic video images by adopting the spectacle method, which is a method making use of shutter spectacles, as the video image watching method.

As shown in the figure, a display screen 1 alternately shows video images for the left eyes and video images for the right eyes. The video images for the left eyes and video images for the right eyes consecutively appear on the display screen 1 as video images arranged along the time axis. To put it more concretely, the display screen 1 shows a left-eye video image L1, a right-eye video image R1, a left-eye video image L2, a right-eye video image R2, a left-eye video image L3, a right-eye video image R3 and so on.

The user watching the 3-d stereoscopic video images wears shutter spectacles 2. The shutter spectacles 2 receive a timing signal for determining timings to open and close two shutters which are employed in the shutter spectacles 2 to serve as respectively a shutter for the left eye and a shutter for the right eye. Each of the shutters employed in the shutter spectacles 2 is a liquid crystal device. The liquid-crystal device for the left eye has a polarization characteristic which is different from the polarization characteristic of the liquid-crystal device for the right eye. The shutter spectacles 2 carry out two different shutter opening and closing operations. To be more specific, the shutter spectacles 2 alternately and repeatedly carry out an operation to open the shutter for the left eye while closing the shutter for the right eye and an operation to close the shutter for the left eye while opening the shutter for the right eye in synchronization with the timing signal. As a result, only the video images for the left eye are supplied to the left eye of the user and only the video images for the right eye are supplied to the right eye of the user.

A disparity between every video image for the left eye and every counterpart video image for the right eye has been provided for the video image for the left eye and the counterpart video image for the right eye. Even though every video image for the left eye and every video image for the right eye are each a 2-d video image, the disparity between every video image for the left eye and the associated video image for the right eye allows the user to sense the video images for the left eye and the video images for the right eye as a 3-d stereoscopic video image.

As described above, in order to watch a 3-d stereoscopic video image by adoption of the spectacle method, it is necessary to provide shutter spectacles capable of receiving a timing signal which is synchronized with the 2-d video images representing the 3-d stereoscopic video image.

### SUMMARY OF THE INVENTION

However, watching of 3-d stereoscopic video image contents cannot be said to have been popularized widely yet. In the present state of the art, an apparatus for displaying video images generally does not have a function to output a timing signal. A typical example of the apparatus for displaying video images is the TV receiver.

Addressing the problem described above, inventors of the present invention have proposed a signal generation apparatus making a display apparatus capable of displaying a 3-d stereoscopic video image content to the user even if the display apparatus for displaying the video image content does not have a function to output a timing signal.

A signal generation apparatus according to a first embodiment of the present invention includes:

bit-clock extraction means for receiving a digital audio signal output by an apparatus for displaying a two-dimensional video image used for sensing a three-dimensional stereoscopic video image on a screen determined in advance and for extracting a bit clock signal from the digital audio signal; and

timing-signal generation means for generating a timing signal having the same period as a vertical synchronization signal of the two-dimensional video image from the bit clock signal extracted by the bit-clock extraction means.

In accordance with the first embodiment of the present invention:

the bit-clock extraction means receives a digital audio signal output by an apparatus for displaying a 2-d video image used for sensing a 3-d stereoscopic video image on a screen determined in advance and extracts a bit clock signal from the digital audio signal; and

the timing-signal generation means generates a timing signal having the same period as a vertical synchronization signal of the 2-d video image from the bit clock signal extracted by the bit-clock extraction means.

Shutter spectacles according to a second embodiment of the present invention includes:

bit-clock extraction means for receiving a digital audio signal output by an apparatus for displaying a two-dimensional video image used for sensing a three-dimensional stereoscopic video image on a screen determined in advance and for extracting a bit clock signal from the digital audio signal;

timing-signal generation means for generating a timing signal having the same period as a vertical synchronization signal of the two-dimensional video image from the bit clock signal extracted by the bit-clock extraction means; and

shutter driving means for driving a shutter for a left eye and a shutter for a right eye on the basis of the timing signal generated by the timing-signal generation means.

In accordance with the second embodiment of the present invention:

the bit-clock extraction means receives a digital audio signal output by an apparatus for displaying a 2-d video image used for sensing a 3-d stereoscopic video image on a screen determined in advance and extracts a bit clock signal from the digital audio signal;

the timing-signal generation means generates a timing signal having the same period as a vertical synchronization signal of the 2-d video image from the bit clock signal extracted by the bit-clock extraction means; and

the shutter driving means drives a shutter for the left eye and a shutter for the right eye on the basis of the timing signal generated by the timing-signal generation means.

In accordance with the first and second embodiments of the present invention, it is possible to display a 3-d stereoscopic video image content even if an apparatus for displaying the video image content does not have a function to output a timing signal.

### BRIEF DESCRIPTION OF THE DRAWINGS

FIG. 1 is a diagram showing the principle of watching 3-d stereoscopic video images by adopting the spectacle method, which is a method making use of shutter spectacles, as a 3-d stereoscopic video image watching method;

FIG. 2 is a diagram showing a typical configuration of the 3-d stereoscopic video image watching system according to a first embodiment of the present invention;

FIG. 3 is a block diagram showing the configuration of a timing-signal generation apparatus employed in the 3-d stereoscopic video image watching system shown in the diagram of FIG. 2;

FIG. 4 is a diagram showing a relation between 2-d video images and a timing signal eventually output by the timing-signal generation apparatus;

FIG. 5 is an explanatory diagram to be referred to in description of an audio signal conforming to the IEC60958 standard;

FIG. 6 is a diagram showing the transmission format of the audio signal conforming to the IEC60958 standard;

FIG. 7 is a table showing relations between sampling frequencies and bit clock frequencies;

FIGS. 8A and 8B are a plurality of tables each showing relations between bit clock frequencies and frequency division rates;

FIG. 9 shows a flowchart representing timing-signal generation processing carried out by the timing-signal generation apparatus;

FIG. 10 is a diagram showing a typical configuration of the 3-d stereoscopic video image watching system according to a second embodiment of the present invention;

FIG. 11 is a block diagram showing the configuration of intelligent shutter spectacles;

FIG. 12 shows a flowchart representing timing-signal generation processing carried out by the intelligent shutter spectacles;

FIG. 13 is a diagram showing a typical configuration of the 3-d stereoscopic video image watching system according to a third embodiment of the present invention; and

FIG. 14 is a diagram showing a typical configuration of the 3-d stereoscopic video image watching system according to a fourth embodiment of the present invention.

### DETAILED DESCRIPTION OF THE PREFERRED EMBODIMENTS

Preferred embodiments of the present invention are explained in chapters which are arranged in an order shown below. In the following description, each of the preferred embodiments is referred to merely as an embodiment.
Chapter 1: First Embodiment

This chapter explains the configuration of a timing-signal generation apparatus 22 for generating a timing signal to be supplied to shutter spectacles 23 external to the timing-signal generation apparatus 22.
Chapter 2: Second Embodiment

This chapter explains the configuration of intelligent shutter spectacles 61 employing the timing-signal generation apparatus for generating a timing signal to be supplied to a shutter driving section 71 also employed in the intelligent shutter spectacles 61.
Chapter 3: Third Embodiment

This chapter explains the configuration of a 3-d stereoscopic video image watching system including a wireless head phone.
Chapter 4: Fourth Embodiment

This chapter explains the configuration of a 3-d stereoscopic video image watching system including a reproduction apparatus.

### Chapter 1: First Embodiment

### Configuration of the First Embodiment

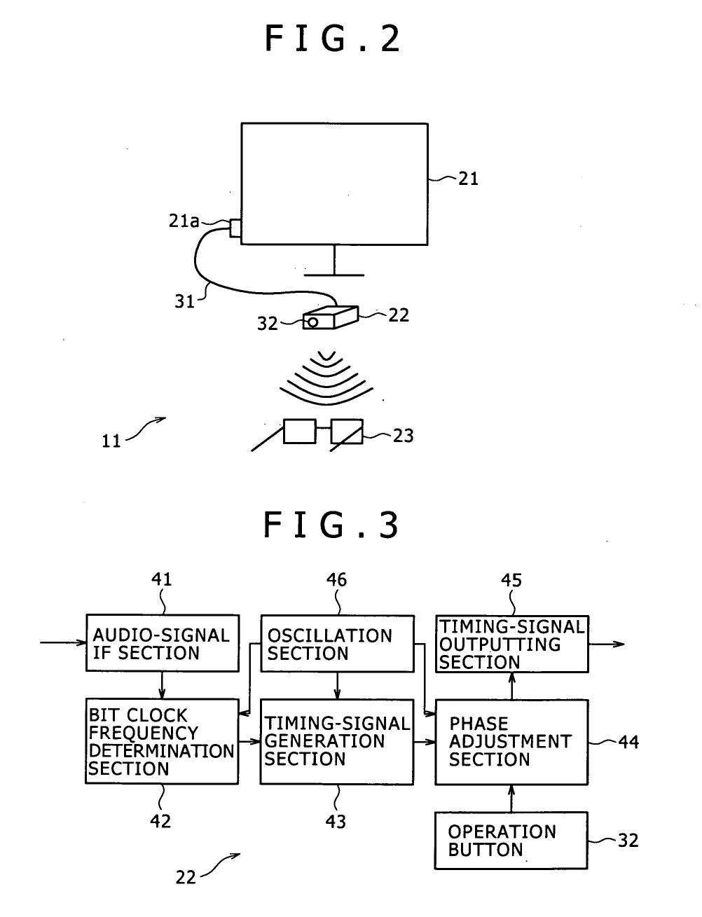

FIG. 2 is a diagram showing a typical configuration of a 3-d stereoscopic video image watching system 11 according to a first embodiment of the present invention.

The 3-d stereoscopic video image watching system 11 shown in the diagram of FIG. 2 is a system provided with a timing-signal generation apparatus 22 and shutter spectacles 23 to serve as a system for watching a 3-d stereoscopic video image by adoption of a spectacle method which makes use of the shutter spectacles 23 external to the timing-signal generation apparatus 22. As shown in the figure, the 3-d stereoscopic video image watching system 11 also employs a TV receiver 21 in addition to the timing-signal generation apparatus 22 and the shutter spectacles 23.

The TV receiver 21 is configured to include a flat-panel display screen such as an LCD screen or a PDP display screen. The TV receiver 21 displays 2-d video images based on 3-d stereoscopic data to serve as video images used for allowing the user to sense a 3-d stereoscopic video image obtained as a result of watching the 2-d video images. The TV receiver 21 is capable of receiving the 3-d stereoscopic video image data as a broadcast signal.

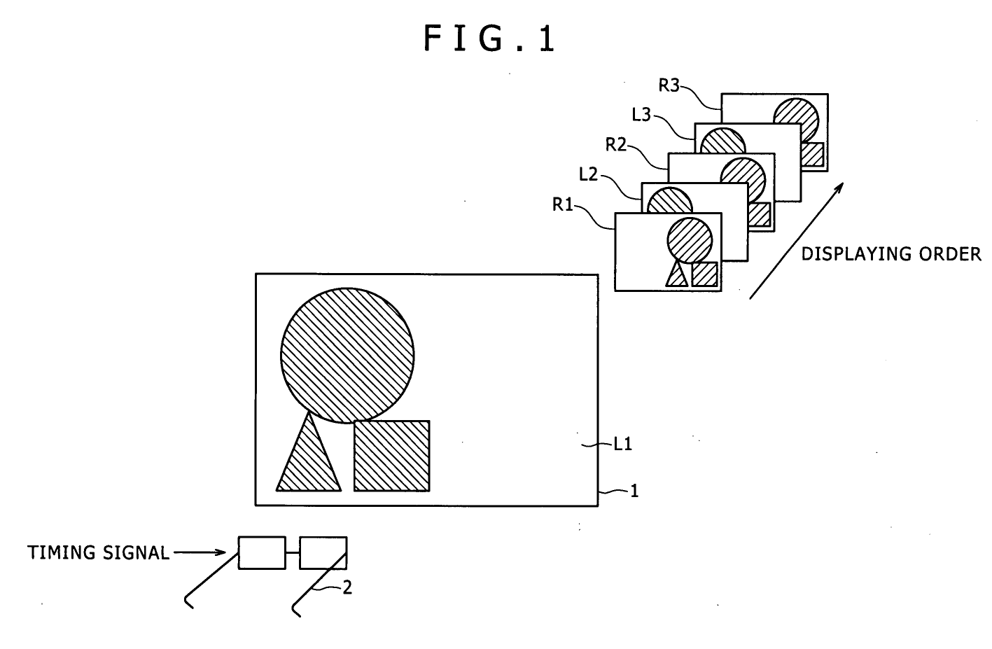

As explained earlier by referring to the diagram of FIG. 1, the 2-d video images displayed by the TV receiver 21 include video images for the left eye and video images for the right eye. The TV receiver 21 displays the video images for the left eye and the video images for the right eye alternately and repeatedly. A disparity between every video image for the left eye and every counterpart video image for the right eye has been provided for the video image for the left eye and the counterpart video image for the right eye.

In this specification, a 2-d video image is a 2-d video image used for allowing the user to sense a 3-d stereoscopic video image obtained as a result of watching a plurality of such 2-d video images.

It is to be noted that the format of the 3-d stereoscopic video image data received by the TV receiver 21 is not prescribed in particular. A typical example of the format of the 3-d stereoscopic video image data received by the TV receiver 21 is a format of including a video image for the left eye and the right-eye video image associated with the video image for the left eye as a set. Another typical example of the format of the 3-d stereoscopic video image data received by the TV receiver 21 is a format of including a 2-d video image and the information on the depths of the 2-d video image as a set.

The TV receiver 21 does not have an output terminal for outputting a timing signal demanded by the shutter spectacles 23 worn by the user who is watching 3-d stereoscopic video images by adoption of the spectacle method. However, the TV receiver 21 is provided with a digital audio output terminal 21a for outputting a digital audio signal conforming to the IEC (International Electrotechnical Commission) 60958 standard which is also referred to as the S/PDIF (Sony Philips Digital Inter Face) standard. There are some types of the digital audio output terminal 21a which conforms to the IEC60958 standard. The types of the digital audio output terminal 21a conforming to the IEC60958 standard include an optical digital audio output terminal and a coaxial digital audio output terminal.

The timing-signal generation apparatus 22 is connected to the digital audio output terminal 21a of the TV receiver 21 by a cable 31. If the digital audio output terminal 21a of the TV receiver 21 is an optical digital audio output terminal, an optical cable is used as the cable 31. If the digital audio output terminal 21a of the TV receiver 21 is a coaxial digital audio output terminal, on the other hand, a coaxial cable is used as the cable 31. It is to be noted that many contemporary video-image display apparatus have an optical digital audio output terminal.

The timing-signal generation apparatus 22 receives an audio signal from the TV receiver 21 which transmits the signal to the timing-signal generation apparatus 22 through the cable 31. The timing-signal generation apparatus 22 generates a timing signal from the audio signal received from the TV receiver 21. The timing signal is a signal synchronized to 2-d video images which are displayed on the TV receiver 21. Then, the timing-signal generation apparatus 22 transmits the timing signal generated thereby to the shutter spectacles 23 by radio communication such as the infrared communication or the RF (radio frequency) communication.

It is to be noted that the timing-signal generation apparatus 22 has an operation button 32. Functions of the operation button 32 will be described later.

The shutter spectacles 23 have the function of a signal receiving apparatus. That is to say, the shutter spectacles 23 are capable of receiving the timing signal from the timing-signal generation apparatus 22 which transmits the timing signal by the radio communication. Much like the shutter spectacles 2 shown in the diagram of FIG. 1, the shutter spectacles 23 have liquid-crystal devices each serving as a shutter which is driven on the basis of the timing signal received from the timing-signal generation apparatus 22. The shutter spectacles 23 receive a timing signal for determining timings to open and close shutters which are employed in the shutter spectacles 23 to serve as a shutter for the left eye and a shutter for the right eye. Each of the shutters employed in the shutter spectacles 23 is a liquid crystal device as described above. The liquid-crystal device for the left eye has a polarization characteristic which is different from the polarization characteristic of the liquid-crystal device for the right eye. The shutter spectacles 23 carry out two different shutter opening and closing operations. To be more specific, the shutter spectacles 23 alternately and repeatedly carry out an operation to open the shutter for the left eye while closing the shutter for the right eye and an operation to close the shutter for the left eye while opening the shutter for the right eye in synchronization with the timing signal received from the timing-signal generation apparatus 22. By driving the shutter for the left eye and the shutter for the right eye on the basis of the timing signal received from the timing-signal generation apparatus 22, only the video images for the left eye are supplied to the left eye of the user and only the video images for the right eye are supplied to the right eye of the user.

Even though every video image for the left eye and every video image for the right eye are each a 2-d video image, the disparity between every video image for the left eye and the associated video image for the right eye allows the user wearing the shutter spectacles 23 to sense the video images for the left eye and the video images for the right eye as a 3-d stereoscopic video image.

### Configuration of the Timing-Signal Generation Circuit 22

FIG. 3 is a block diagram showing the configuration of the timing-signal generation apparatus 22 employed in the 3-d stereoscopic video image watching system 11 shown in the diagram of FIG. 2.

As shown in the block diagram, the configuration of the timing-signal generation apparatus 22 includes an operation button 32, an audio-signal IF section 41, a bit clock frequency determination section 42, a timing-signal generation section 43, a phase adjustment section 44, a timing-signal outputting section 45 and an oscillation section 46.

The audio-signal IF section 41 is a section for receiving an audio signal from the TV receiver 21 which transmits the audio signal to the timing-signal generation apparatus 22 through the cable 31. In addition, the audio-signal IF section 41 also extracts a clock signal from the audio signal received from the TV receiver 21. The audio-signal IF section 41 then supplies the clock signal extracted from the audio signal IF section 41 to the bit clock frequency determination section 42. It is to be noted that a signal receiving interface device generally put in the market as a signal receiving interface device conforming to the IEC60958 standard can be used to serve as the audio-signal IF section 41. In the following description, the clock signal extracted by the audio-signal IF section 41 from the audio signal is particularly referred to as a bit clock signal whereas the frequency of the bit clock signal is also referred to as a bit clock frequency.

The bit clock frequency determination section 42 measures the frequency of the bit clock signal received from the audio-signal IF section 41 on the basis of a reference clock signal generated by the oscillation section 46. Then, by referring to a table shown in the diagram of FIG. 7, the bit clock frequency determination section 42 recognizes a sampling frequency of the audio signal received from the TV receiver 21 from a bit clock frequency which results from the frequency measurement as the frequency of the bit clock signal. To put it more concretely, the sampling frequency of the audio signal received from the TV receiver 21 can be one of frequencies which include 32 kHz, 44.1 kHz, 48 kHz, 96 kHz and 192 kHz as listed in the table shown in the diagram of FIG. 7. The bit clock frequency determination section 42 identifies one of these frequencies as the sampling frequency. Subsequently, the bit clock frequency determination section 42 supplies information on the identified sampling frequency of the audio signal received from the TV receiver 21 and the bit clock signal to the timing-signal generation section 43.

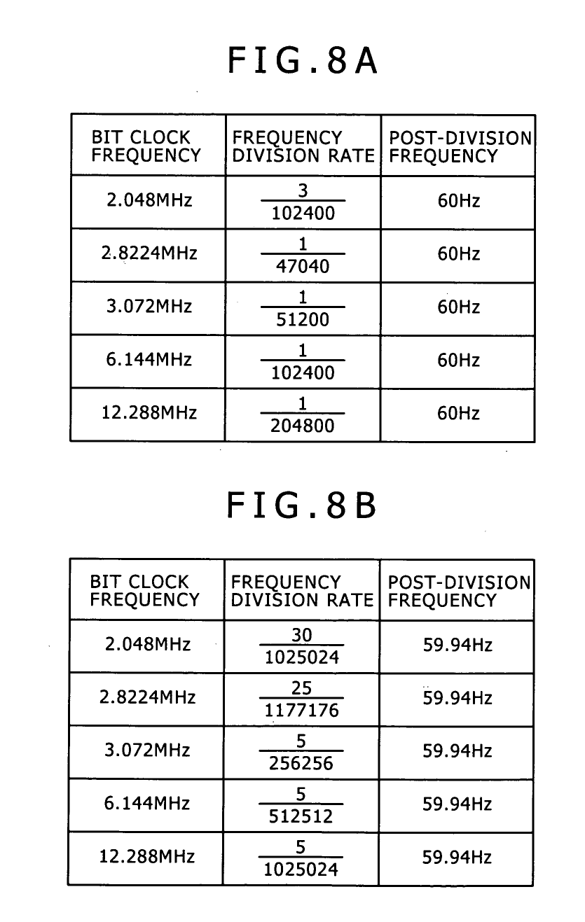

The timing-signal generation section 43 is a section for generating a timing signal by making use of pieces of information which have been received by the timing-signal generation section 43 from the bit clock frequency determination section 42 as information on the identified sampling frequency of the audio signal and information on the frequency of the bit clock signal. The timing signal generated by the timing-signal generation section 43 is a signal having the same period as a vertical synchronization signal which is used in an operation to display a 2-d video image. Details of the processing carried out by the timing-signal generation section 43 will be described later by referring to tables shown in FIGS. 8A and 8B. In the processing, the frequency of the bit clock signal is divided by a frequency division ratio in order to generate the timing signal which has the same period as the vertical synchronization signal. In actuality, the frequency of the bit clock signal is multiplied by a frequency division rate which is the reciprocal of the frequency division ratio.

The timing-signal generation section 43 supplies the timing signal generated thereby to the phase adjustment section 44. The timing signal generated by the timing-signal generation section 43 has a frequency matching the frequency of the vertical synchronization signal, but there is no assurance that the phase of the timing signal matches the phase of the vertical synchronization signal. However, the user is allowed to operate the operation button 32 in order to adjust the phase of the timing signal generated by the timing-signal generation section 43 to the phase of the vertical synchronization signal.

That is to say, if the phase of the timing signal does not match the phase of the vertical synchronization signal, the user cannot sense 2-d video images displayed on the TV receiver 21 as a 3-d stereoscopic video image. However, the user can keep operating the operation button 32 by pressing the operation button 32 till the user senses 2-d video images displayed on the TV receiver 21 as a 3-d stereoscopic video image. When the user presses the operation button 32, a signal generated by the operation button 32 is supplied to the phase adjustment section 44. While the user is pressing the operation button 32, the signal generated by the operation button 32 is driving the phase adjustment section 44 to carry out processing to shift the phase of the timing signal received by the phase adjustment section 44 from the timing-signal generation section 43.

In addition, it is even more desirable to display the so-called determination video image on the TV receiver 21 at the phase adjustment time. The determination video image is an image used for easily determining whether or not the 3-d stereoscopic video image watching system 11 has been put in a state in which the user can sense 2-d video images displayed on the TV receiver 21 as a 3-d stereoscopic video image. A typical example of the determination video image used for easily determining whether or not the 3-d stereoscopic video image watching system 11 has been put in the state is an image which is seen as a simple video image such as a stick when the 3-d stereoscopic video image watching system 11 has been put in such a state.

After the phase adjustment section 44 has adjusted the phase of the timing signal, the phase adjustment section 44 supplies the timing signal having the adjusted phase to the timing-signal outputting section 45. With the operation button 32 not pressed by the user, on the other hand, the phase adjustment section 44 passes on the timing signal received from the timing-signal generation section 43 to the timing-signal outputting section 45 with the phase of the timing signal kept as it is.

The timing-signal outputting section 45 converts the timing signal received from the phase adjustment section 44 into an output signal such as an infrared signal or an RF (radio frequency) signal and transmits the output signal to the shutter spectacles 23. Thus, the timing-signal outputting section 45 can thus be designed as an infrared communication module or an RF communication module.

The oscillation section 46 is typically a liquid-crystal oscillator for generating the reference clock signal cited above. The oscillation section 46 supplies the reference clock signal to the bit clock frequency determination section 42, the timing-signal generation section 43 and the phase adjustment section 44. In the first embodiment, the oscillation section 46 generates the reference clock signal having a frequency of 1 MHz.

As described above, the timing-signal generation apparatus 22 is configured to generate a timing signal by making use of a digital audio signal received from the digital audio output terminal 21a of the TV receiver 21 and transmit the timing signal to the shutter spectacles 23.

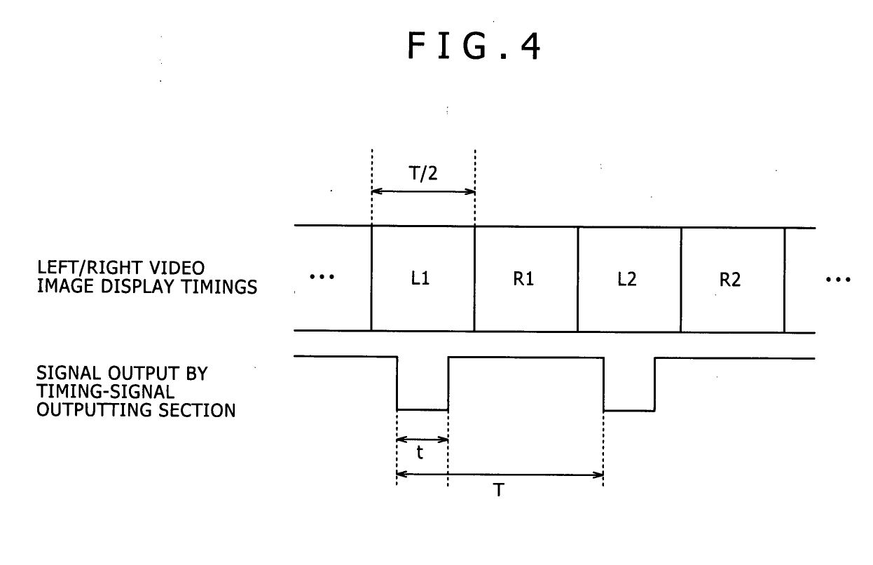

Next, processing carried out by the sections composing the timing-signal generation apparatus 22 are explained in detail by referring to diagrams of FIGS. 4 to 8B.

### Output Signal

FIG. 4 is a diagram showing a relation between 2-d video images and a timing signal eventually output by a timing-signal generation apparatus 22 as an output signal. The 2-d video images are video images L1, L2 and so on for the left eye and video images R1, R2 and so on for the right eye.

Let the TV receiver 21 display a pair of 2-d video images, that is, a 2-d video image for the left eye and a 2-d video image for the right eye, in a time period T [msec]. In this case, a time period demanded for displaying a 2-d video image for the left eye or a 2-d video image for the right eye has a length of T/2 [msec]. The timing signal demanded in the operation to display such 2-d video images is the timing signal shown in the diagram of FIG. 4. This timing signal is a signal generated and output by the timing-signal generation apparatus 22 as a signal having, the same period and the same phase as respectively the period and phase of the vertical synchronization signal cited before. To put it more concretely, the timing signal is a pulse signal set at a low level during a sub-period t [msec] of the time period T [msec] and a high level during the rest of the time period T [msec]. In addition, the sub-period for setting the timing signal at the low level is positioned at the center of the period for displaying a video image for the left eye and a video image for the right eye. Audio Signal Conforming to the IEC60958 Standard

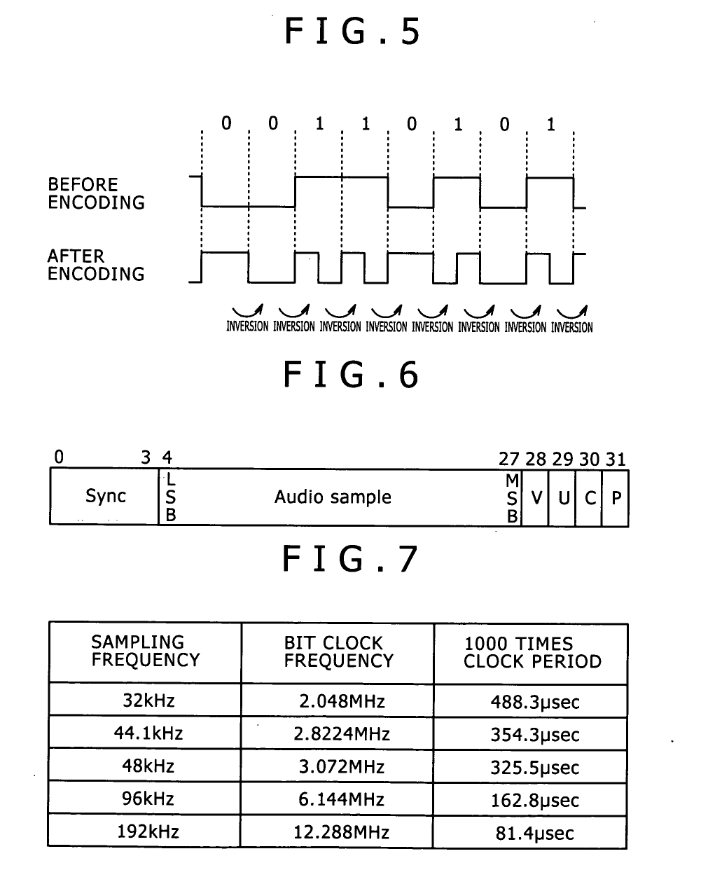

FIG. 5 is an explanatory diagram to be referred to in description of an audio signal output from the digital audio output terminal 21a of the TV receiver 21 as an audio signal conforming to the IEC60958 standard.

As shown in the figure, the audio signal conforming to the IEC60958 standard is a serial digital signal. The audio signal conforming to the IEC60958 standard is a signal obtained as a result of an encoding process adopting an encoding method which is referred to as a bi-phase encoding method. FIG. 5 is an explanatory diagram showing an audio signal used as an input to an encoding process adopting the bi-phase encoding method on the upper side of the diagram and an audio signal obtained as a result of the encoding process on the lower side of the diagram.

In the encoding process adopting the bi-phase encoding method, a signal used as an input to the encoding process is encoded in accordance with the following rules. If the signal used as an input to the encoding process represents data of 1, the period of the signal obtained as a result of the encoding process is converted into a period having a length equal to two times the length of the period of the signal used as an input to the encoding process. If the signal used as an input to the encoding process represents data of 0, on the other hand, the period of the signal used as an input to the encoding process is used as it is as the period of the signal resulting from the encoding process. In the following description, the signal used as an input to the encoding process is also referred to as an input signal whereas the signal obtained as a result of the encoding process is also referred to as an output signal.

In addition, in the encoding process adopting the bi-phase encoding method, during every period representing 1 bit, the signal is always inverted.

Since the audio signal obtained as a result of the encoding process is always inverted during every period representing 1 bit, a bit clock signal serving as a clock signal corresponding to 1 bit can be extracted from the audio signal even if a clock signal itself is not transmitted.

### Transmission Format of the Audio Signal Conforming to the IEC60958 Standard

FIG. 6 is a diagram showing the transmission format of an audio signal conforming to the IEC60958 standard.

An audio signal conforming to the IEC60958 standard is transmitted in units which are each referred to as a sub-frame. FIG. 6 is a diagram showing a sub-frame.

As shown in the figure, a sub-frame is used to accommodate an audio sample for the L (left) or R (right) channel. The audio sample is data representing the amplitude of a sound. Two sub-frames form a unit referred to as a frame. The two sub-frames forming a frame are a sub-frame of the L channel and a sub-frame of the R channel. 192 consecutive frames further form a unit referred to as a block.

A sub-frame is configured to have a length of 32 bits.

4 bits at the left end of the figure are 4 most significant bits of the sub-frame. These 4 most significant bits of the sub-frame form a bit pattern for detecting synchronization. These 4 most significant bits of the sub-frame are referred to as a sync code or a pre-amble code.

The 5^{th} bit (bit 4) to the 28^{th} bit (bit 27) from the most significant bit (bit 0) of the sub-frame are used to accommodate the audio sample which is data representing the amplitude of a sound as described above.

The 29^{th} bit (bit 28) from the most significant bit of the sub-frame is a V (validity) bit referred to as a validity flag. The validity flag is a flag used for indicating whether the sub-frame is valid or not. The 30^{th} bit (bit 29) following the V bit is a U bit referred to as a user data bit. The 31^{st} bit (bit 30) following the U bit is a C bit referred to as a channel status bit. The 32^{nd} bit (bit 31) following the C bit is a P bit referred to as a parity bit.

### Processing of the Bit-Clock-Frequency Determination Section 42

FIG. 7 is a table showing relations between sampling frequencies and bit clock frequencies. Processing carried out by the bit-clock-frequency determination section 42 is explained by referring to the table of FIG. 7 as follows.

The bit clock frequency determination section 42 is a section for measuring the frequency of the bit clock signal received from the audio-signal IF section 41 on the basis of the reference clock signal received from the oscillation section 46.

The following description explains processing carried out by the bit clock frequency determination section 42 to measuring the frequency of the bit clock signal received from the audio-signal IF section 41 on the basis of the reference clock signal received from the oscillation section 46. As a typical case, let the sampling frequency of the audio signal received from the TV receiver 21 be 48 kHz.

At a sampling frequency of 48 kHz, let the audio signal received from the TV receiver 21 be a stereo audio signal for the L (left) and R (right) channels. In this case, the stereo audio signal having a sampling frequency of 48 kHz is transmitted in sub-frame units which each have a length of 32 bits. Thus, the frequency of the bit clock signal received from the audio-signal IF section 41 satisfies the following equation:

Frequency=48 [kHz]×2 [ch]×32 [bits]=3.072 [MHz]

That is to say, the bit clock frequency in this case is found to be 3.072 MHz.

For sampling frequencies of 32 kHz, 44.1 kHz, 96 kHz and 192 kHz, the bit clock frequency can be computed in the same way as the sampling frequency of 48 kHz.

FIG. 7 is a table showing a relation between the sampling frequency and the bit clock frequency.

As described above, the bit clock frequency determination section 42 measures the bit clock frequency of the bit clock signal received from the audio-signal IF section 41 on the basis of the reference clock signal received from the oscillation section 46. Then, by making use of the equation described above, the bit clock frequency determination section 42 recognizes a sampling frequency of the audio signal received from the TV receiver 21 from the bit clock frequency which results from the measurement as the frequency of the bit clock signal. However, even though the frequency of the reference clock signal received from the oscillation section 46 is 1 MHz, the bit clock frequency being measured is at least 2.048 MHz which is higher than the frequency of the reference clock signal. That is to say, the bit clock period being measured is too short to be measured in terms of reference clock periods. In order to solve this problem, the bit clock frequency determination section 42 divides the bit clock frequency and measures the bit clock period of a bit clock signal obtained as a result of the frequency division in order to find the bit clock frequency of the post-frequency-division bit clock signal.

In the first embodiment, the bit clock frequency determination section 42 divides the bit clock frequency by 1,000 and measures the period of a bit clock signal obtained as a result of the frequency division by making use of the reference clock signal. That is to say, the bit clock frequency determination section 42 measures the period of a bit clock signal obtained as a result of the frequency division in terms of reference clock periods. The reference clock period is the period of the reference clock signal generated by the oscillation section 46.

FIG. 7 is a table showing bit clock frequencies and bit clock periods on the rightmost column. The bit clock periods are obtained as a result of dividing the bit clock frequency by 1,000 for sampling frequencies of 32 kHz, 44.1 kHz, 48 kHz, 96 kHz and 192 kHz.

The period of the reference clock signal generated by the oscillation section 46 is 1/1 MHz=1 microsecond. Thus, the bit clock period obtained as a result of dividing the bit clock frequency by 1,000 can be measured in terms of reference clock periods. If the bit clock period obtained as a result of dividing the bit clock frequency by 1,000 is found to be 325 reference clock periods or 325 microseconds for example, the bit clock frequency determination section 42 determines that the bit clock frequency is 3.072 MHz.

### Processing of the Timing-Signal Generation Section 43

Next, processing carried out by the timing-signal generation section 43 is explained as follows.

The timing-signal generation section 43 is a section for generating a timing signal by making use of pieces of information which have been received by the timing-signal generation section 43 from the bit clock frequency determination section 42 as information on the identified sampling frequency of the audio signal and information on the frequency of the bit clock signal. The timing signal generated by the timing-signal generation section 43 is a signal having the same period as a vertical synchronization signal which is used in an operation to display a 2-d video image.

FIGS. 8A and 8B are a plurality of tables each showing relations between bit clock frequencies and frequency division rates.

To be more specific, FIG. 8A is a table showing relations between bit clock frequencies and frequency division rates for generation of a timing signal having a frequency of 60 Hz.

On the other hand, FIG. 8B is a table showing relations between bit clock frequencies and frequency division rates for generation of a timing signal having a frequency of 59.94 Hz.

The timing-signal generation apparatus 22 determines in advance whether the frequency of the timing signal to be generated by the timing-signal generation section 43 is 60 Hz or 59.94 Hz. As is obvious from the above description, the frequency of the timing signal to be generated by the timing-signal generation section 43 is the frequency of a vertical synchronization signal which is used in an operation to display a 2-d video image on the TV receiver 21.

The timing-signal generation section 43 receives the bit clock frequency and the bit clock signal from the bit clock frequency determination section 42. Let the timing-signal frequency determined in advance by the timing-signal generation section 43 be 60 Hz. In this case, if the bit clock frequency is 3.072 MHz, the timing-signal generation section 43 selects the frequency division rate of 1/51200 for the bit clock frequency of 3.072 MHz. Then, the timing-signal generation section 43 divides the bit clock frequency of 3.072 MHz by 51,200 in order to result in a timing-signal frequency of 60 Hz which is equal to the frequency of a vertical synchronization signal used in an operation to display a 2-d video image on the TV receiver 21. For any other bit clock frequency, the timing-signal generation section 43 selects a frequency division rate for the other bit clock frequency and computes the frequency of a timing signal being generated in the same way as the bit clock frequency of 3.072 MHz.

As another example, let the timing-signal frequency determined in advance by the timing-signal generation section 43 be 59.94 Hz. In this case, if the bit clock frequency is 6.144 MHz, the timing-signal generation section 43 selects the frequency division rate of 5/512512 for the bit clock frequency of 6.144 MHz. Then, the timing-signal generation section 43 multiplies the bit clock frequency of 6.144 MHz by the frequency division rate of 5/512512 in order to result in a timing-signal frequency of 59.94 Hz which is equal to the frequency of a vertical synchronization signal used in an operation to display a 2-d video image on the TV receiver 21. For any other bit clock frequency, the timing-signal generation section 43 selects a frequency division rate for the other bit clock frequency and computes the frequency of a timing signal being generated in the same way as the bit clock frequency of 6.144 MHz.

### Timing-Signal Generation Processing

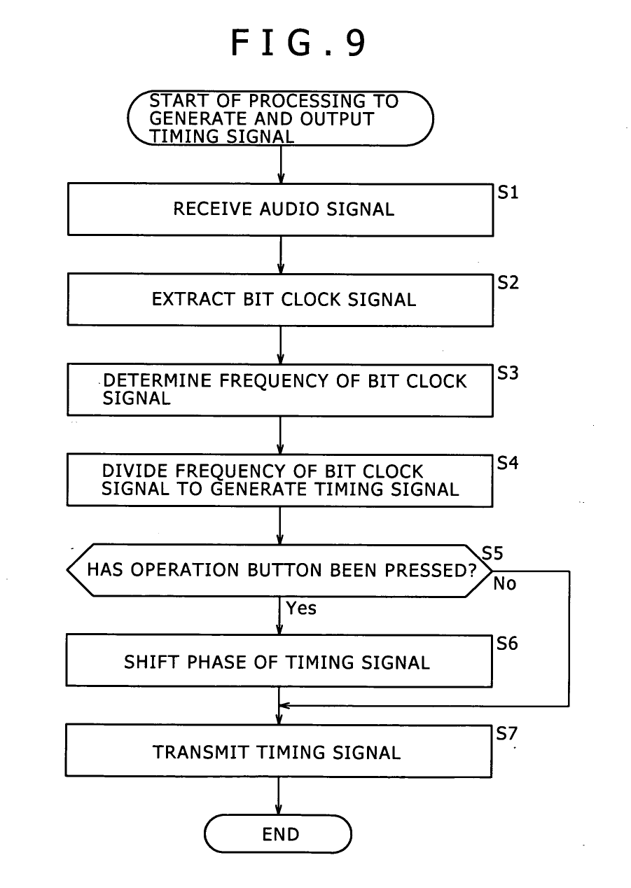

FIG. 9 shows a flowchart representing timing-signal generation processing carried out by the timing-signal generation apparatus 22. The timing-signal generation processing to be carried out by the timing-signal generation apparatus 22 is started when the timing-signal generation apparatus 22 receives an audio signal from the TV receiver 21 which transmits the audio signal to the timing-signal generation apparatus 22 through the cable 31.

As shown in the figure, the flowchart begins with a step S1 at which the audio-signal IF section 41 employed in the timing-signal generation apparatus 22 receives an audio signal from the TV receiver 21 which transmits the audio signal to the audio-signal IF section 41 through the cable 31.

Then, at the next step S2, the audio-signal IF section 41 extracts a bit clock signal from the audio signal received from the TV receiver 21 and supplies the bit clock signal to the bit clock frequency determination section 42.

Subsequently, at the next step S3, the bit clock frequency determination section 42 measures the bit clock frequency which is the frequency of the bit clock signal received from the audio-signal IF section 41. To put it more concretely, the bit clock frequency determination section 42 divides the frequency of the bit clock signal by 1,000 and measures the period of a bit clock signal obtained as a result of the frequency division in terms of reference clock periods. The reference clock period is the period of the reference clock signal received from the oscillation section 46. Then, the bit clock frequency determination section 42 collates the period of a bit clock signal obtained as a result of the frequency division with periods shown on the rightmost column of the table shown in FIG. 7 in order to determine the bit clock frequency and the sampling frequency of the audio signal. The determined bit clock frequency and the determined sampling frequency of the audio signal are respectively a bit clock frequency and a sampling frequency which are associated with a period matching the measured period of a bit clock signal obtained as a result of the frequency division. Subsequently, the bit clock frequency determination section 42 supplies the determined bit clock frequency and the determined sampling frequency of the audio signal to the timing-signal generation section 43.

Then, at the next step S4, the timing-signal generation section 43 selects a frequency division rate from a frequency division rate table internally stored in the timing-signal generation section 43. The frequency division rate selected from the frequency division rate table is a frequency division rate corresponding to the bit clock frequency which has been received from the bit clock frequency determination section 42. The frequency division rate table internally stored in the timing-signal generation section 43 is one of the tables shown in FIGS. 8A and 8B. Subsequently, the timing-signal generation section 43 multiplies the bit clock frequency received from the bit clock frequency determination section 42 by the frequency division rate selected from the frequency division rate table in order to find the frequency of the timing signal. The timing signal generated by the timing-signal generation section 43 has a period equal to the period of a vertical synchronization signal which is used in an operation to display a 2-d video image on the TV receiver 21. However, it is not obvious that the timing signal generated by the timing-signal generation section 43 has a phase matching the phase of a vertical synchronization signal which is used in an operation to display a 2-d video image on the TV receiver 21.

Subsequently, at the next step S5, the phase adjustment section 44 produces a result of determination as to whether or not the user has pressed the operation button 32. If the determination result produced at the step S5 indicates that the user has not pressed the operation button 32, the flow of the processing goes on to a step S7, skipping a step S6.

If the determination result produced at the step S5 indicates that the user has pressed the operation button 32, on the other hand, the flow of the processing goes on to the step S6 at which the phase adjustment section 44 shifts the phase of the timing signal received from the timing-signal generation section 43 while the user is pressing the operation button 32. As a result, the timing signal generated by the phase adjustment section 44 has a phase synchronized with the phase of a vertical synchronization signal which is used in an operation to display a 2-d video image on the TV receiver 21.

At the step S7, the phase adjustment section 44 supplies the timing signal to the timing-signal outputting section 45. As indicated by the flowchart shown in FIG. 9, the step S7 is carried out after the step S5 or S6. If the step S7 is carried out right after the step S6, the timing signal supplied by the phase adjustment section 44 to the timing-signal outputting section 45 has a phase which has been synchronized at the step S6 with the phase of a vertical synchronization signal used in an operation to display a 2-d video image on the TV receiver 21. If the step S7 is carried out right after the step S5, on the other hand, the timing signal supplied by the phase adjustment section 44 to the timing-signal outputting section 45 has a phase which is the same phase as that of the timing signal supplied by the timing-signal generation section 43 to the phase adjustment section 44. That is to say, in this case, the phase adjustment section 44 passes on the timing signal received from the timing-signal generation section 43 to the timing-signal outputting section 45 with the phase of the timing signal sustained as it is. Then, the timing-signal outputting section 45 converts the timing signal received from the phase adjustment section 44 into an output signal such as an infrared signal or an RF signal and transmits the output signal to the shutter spectacles 23. Finally, the processing sequence is ended.

The processing carried out at the steps S1 to S7 described above is performed repeatedly as long as the TV receiver 21 is transmitting an audio signal to the timing-signal generation apparatus 22 through the cable 31.

As described above, the timing-signal generation apparatus 22 is capable of generating a timing signal from a digital audio signal generated by the TV receiver 21 as a signal conforming to the IEC60958 and transmitting the timing signal to the shutter spectacles 23. Thus, it is possible to watch a 3-d stereoscopic video content by making use of the TV receiver 21 even if the TV receiver 21 does not have a function to output the timing signal.

### Chapter 2: Second Embodiment

### Configuration of the Second Embodiment

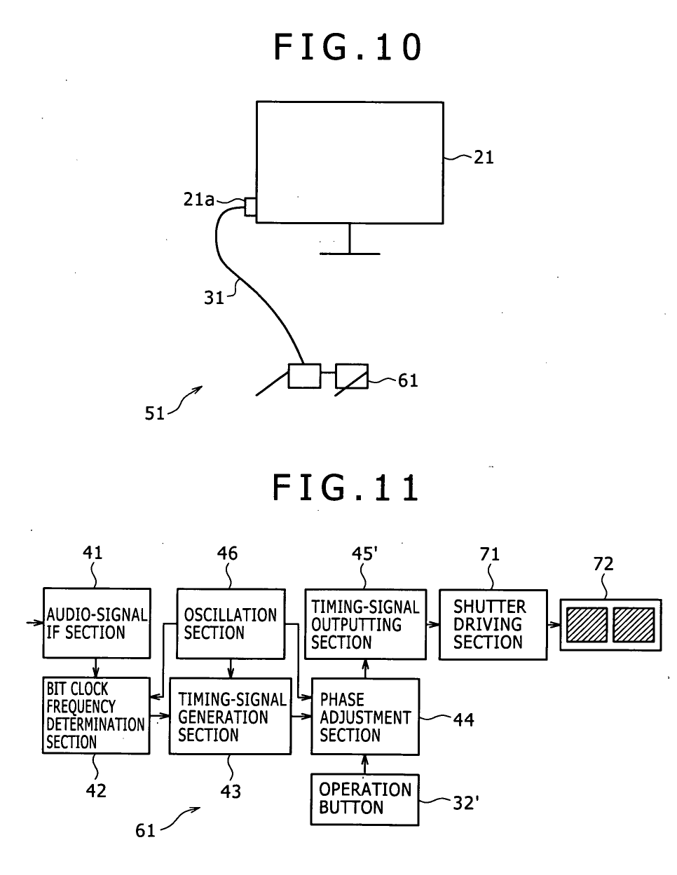

FIG. 10 is a diagram showing a typical configuration of a 3-d stereoscopic video image watching system 51 according to a second embodiment of the present invention.

It is to be noted that configuration elements each employed in the second embodiment to serve as an element identical with its counterpart included in the first embodiment described so far is denoted by the same reference numeral or the same reference notation as the counterpart. In addition, the explanation of the identical configuration elements is omitted in order to avoid duplications of descriptions.

In the 3-d stereoscopic video image watching system 51 shown in the diagram of FIG. 10, intelligent shutter spectacles 61 are connected to the TV receiver 21 by a cable 31. The second embodiment is different from the first embodiment described so far in that, in the case of the second embodiment, the intelligent shutter spectacles 61 include the functions of the timing-signal generation apparatus 22 which is employed in the first embodiment.

Thus, through the cable 31 connecting the intelligent shutter spectacles 61 to the digital audio output terminal 21a of the TV receiver 21, the intelligent shutter spectacles 61 receive a digital audio signal generated by the TV receiver 21 as a signal which conform to the IEC60958.

### Configuration of the Shutter Spectacles 61

FIG. 11 is a block diagram showing the configuration of the shutter spectacles 61 employed in the 3-d stereoscopic video image watching system 51 shown in the diagram of FIG. 10.

Like the timing-signal generation apparatus 22 shown in the block diagram of FIG. 3, the configuration of the shutter spectacles 61 includes an audio-signal IF section 41, a bit clock frequency determination section 42, a timing-signal generation section 43, a phase adjustment section 44 and an oscillation section 46.

In addition, the intelligent shutter spectacles 61 also employ an operation button 32′, a timing-signal outputting section 45′, a shutter driving section 71 and a shutter section 72 which are not included in the timing-signal generation apparatus 22 shown in the block diagram of FIG. 3.

When the user presses the operation button 32′, a signal generated by the operation button 32′ is supplied to the phase adjustment section 44. That is to say, the operation button 32′ has a function identical with the function of the operation button 32 included in the timing-signal generation apparatus 22 shown in the block diagram of FIG. 3. The only difference between the operation button 32′ and the operation button 32 is that the operation button 32′ is provided on the intelligent shutter spectacles 61.

The timing-signal outputting section 45′ passes on a timing signal received from the phase adjustment section 44 to the shutter driving section 71 through an electrical wire. That is to say, the timing-signal outputting section 45′ has a transmission destination and a transmission technique which are different from respectively the transmission destination and transmission technique of the timing-signal outputting section 45 included in the timing-signal generation apparatus 22 shown in the block diagram of FIG. 3.

The shutter driving section 71 is a section for driving a right-eye shutter and a left-eye shutter which are each a liquid-crystal device employed in the shutter section 72. That is to say, on the basis of the timing signal received from the timing-signal outputting section 45′, the shutter driving section 71 generates a driving voltage to be applied to each of the liquid-crystal devices employed in the shutter section 72.

The shutter section 72 has the shutter for the right eye and the shutter for the left eye. Each of the shutter for the right eye and the shutter for the left eye is a liquid-crystal device having two electrodes. When the aforementioned driving voltage of approximately 10 to 20 V is applied between the two electrodes of a shutter for the left or right eye, the shutter operates independently of the other shutter. In the case of this second embodiment, when the shutter driving section 71 applies an electric potential difference of 0V between the two electrodes of a shutter for the left or right eye, the shutter is opened. When the shutter driving section 71 applies an electric potential difference of ±15V between the two electrodes of a shutter for the left or right eye, the shutter is closed.

FIG. 11 is a block diagram showing the configuration of the intelligent shutter spectacles 61.

### Timing-Signal Generation Processing

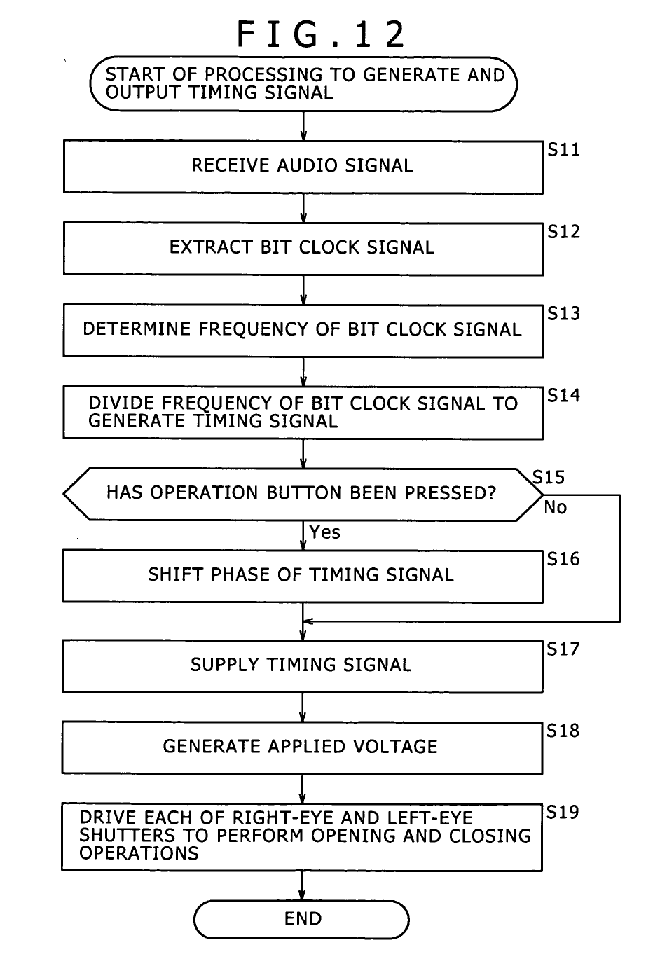

Next, by referring to a flowchart shown in FIG. 12, the following description explains processing carried out by the intelligent shutter spectacles 61 to generate a timing signal. The timing-signal generation processing to be carried out by the timing-signal generation apparatus 61 is started when the intelligent shutter spectacles 61 receives an audio signal from the TV receiver 21 which transmits the audio signal to the shutter spectacles 61 through the cable 31.

The steps S11 to S16 of the flowchart shown in FIG. 12 are identical with respectively the steps S1 to S6 of the flowchart shown in FIG. 9 except that, at the step S15, the phase adjustment section 44 produces a result of determination as to whether or not the user has pressed the operation button 32′ which is a button provided on the intelligent shutter spectacles 61 itself. For this reason, the steps S11 to S16 are not explained in order to avoid duplications of descriptions.

At the step S17, the phase adjustment section 44 supplies the timing signal to the timing-signal outputting section 45′. As indicated by the flowchart shown in FIG. 12, the step S17 is carried out after the step S15 or S16. If the step S17 is carried out right after the step S16, the timing signal supplied by the phase adjustment section 44 to the timing-signal outputting section 45′ has a phase which has been synchronized at the step S16 with the phase of a vertical synchronization signal used in an operation to display a 2-d video image on the TV receiver 21. If the step S17 is carried out right after the step S15, on the other hand, the timing signal supplied by the phase adjustment section 44 to the timing-signal outputting section 45′ has a phase which is the same phase as that of the timing signal supplied by the timing-signal generation section 43 to the phase adjustment section 44. That is to say, in this case, the phase adjustment section 44 passes on the timing signal received from the timing-signal generation section 43 to the timing-signal outputting section 45′ with the phase of the timing signal sustained as it is. Then, the timing-signal outputting section 45′ transmits the timing signal received from the phase adjustment section 44 to the shutter driving section 71 through a wire.

Then, at the next step S18, on the basis of the timing signal received from the timing-signal outputting section 45′, the shutter driving section 71 generates a driving voltage to be applied to the liquid-crystal devices serving as the left-eye and right-eye shutters which are employed in the shutter section 72.

Subsequently, at the next step S19, driven by the driving voltage received from the shutter driving section 71, each of the left-eye and right-eye shutters employed in the shutter section 72 carries out closing and opening operations in accordance with the driving voltage. To put it in detail, when the shutter driving section 71 applies an electric potential difference of 0V between the two electrodes of a shutter for the left or right eye, the shutter is opened. When the shutter driving section 71 applies an electric potential difference of ±15V between the two electrodes of a shutter for the left or right eye, the shutter is closed. Finally, the processing sequence is ended.

The processing carried out at the steps S11 to S19 of the flowchart shown in FIG. 12 as described above is performed repeatedly as long as the TV receiver 21 is transmitting an audio signal to the intelligent shutter spectacles 61 through the cable 31. As the TV receiver 21 no longer transmits an audio signal to the intelligent shutter spectacles 61 through the cable 31, the intelligent shutter spectacles 61 terminate the processing to generate a timing signal.

In accordance with the timing-signal generation processing represented by the flowchart shown in FIG. 12, the intelligent shutter spectacles 61 are capable of generating a timing signal by making use of an audio signal received by the intelligent shutter spectacles 61 from the TV receiver 21 and capable of carrying out shutter operations in accordance with the timing signal. Also by virtue of the second embodiment, it is thus possible to watch a 3-d stereoscopic video content by making use of the TV receiver 21 even if the TV receiver 21 does not have a function to output a timing signal.

In addition, in accordance with the second embodiment, the operation button 32′ used for adjusting the phase of the timing signal is provided on the intelligent shutter spectacles 61. Thus, the user-friendliness of the operation for adjusting the phase of the timing signal is enhanced.

It is to be noted that, for example, the shutter spectacles 23 employed in the 3-d stereoscopic video image watching system 11 shown in the diagram of FIG. 2 can be provided with a phase adjustment function including the operation button 32′ of the intelligent shutter spectacles 61 shown in the diagram of FIG. 11 to serve as a substitute for the phase adjustment function including the operation button 32 of the timing-signal generation apparatus 22 employed in the 3-d stereoscopic video image watching system 11 shown in the diagram of FIG. 2. That is to say, the phase adjustment function including the operation button 32 is transferred from the timing-signal generation apparatus 22 employed in the 3-d stereoscopic video image watching system 11 shown in the diagram of FIG. 2 to the shutter spectacles 23 also employed in the 3-d stereoscopic video image watching system 11 shown in the diagram of FIG. 2. In other words, in a modified version of the first embodiment described above, the timing-signal generation apparatus 22 carries out the operation to generate the timing signal having the same period as the vertical synchronization signal used in an operation to display a 2-d video image on the TV receiver 21 whereas the shutter spectacles 23 provided with the phase adjustment function including the operation button 32′ of the intelligent shutter spectacles 61 adjusts the phase of the timing signal which has been generated by the timing-signal generation apparatus 22. In this modified version of the first embodiment described above, the operation button 32′ is provided on the shutter spectacles 23. Thus, the operation of the operation button 32′ is also very user friendly.

### Chapter 3: Third Embodiment

### Configuration of the Third Embodiment

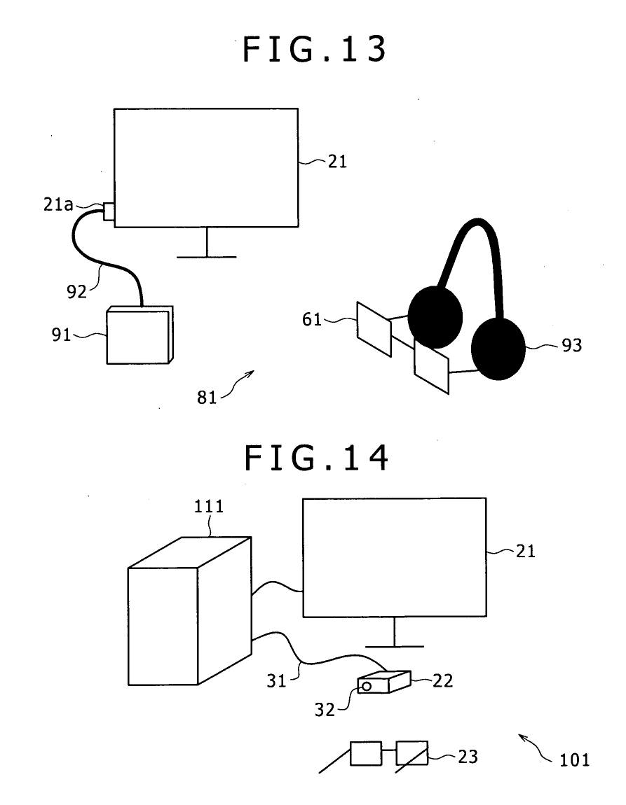

FIG. 13 is a diagram showing a typical configuration of the 3-d stereoscopic video image watching system 81 according to a third embodiment of the present invention.

The third embodiment is different from the second embodiment in that, in the case of the 3-d stereoscopic video image watching system 81 according to the third embodiment, a wireless headphone system is provided between the TV receiver 21 and the intelligent shutter spectacles 61.

In addition, the 3-d stereoscopic video image watching system 81 also has a wireless headphone transmitter 91 which is connected by a cable 92 to the digital audio output terminal 21a of the TV receiver 21. The cable 92 has the same type as the cable 31 used in the 3-d stereoscopic video image watching system 11 shown in the diagram of FIG. 2 and the cable 31 used in the 3-d stereoscopic video image watching system 51 shown in the diagram of FIG. 10. The wireless headphone transmitter 91 receives an audio signal from the TV receiver 21 and transmits the audio signal to a wireless headphone 93 by radio communication such as infrared communication or 2.4-GHz band RF communication.

The wireless headphone 93 receives the audio signal transmitted by the wireless headphone transmitter 91 by radio communication and outputs the audio signal to speakers for the left and right ears. In addition, the wireless headphone 93 also supplies the audio signal to the intelligent shutter spectacles 61 through a cable not shown in the diagram of FIG. 13. The cable connects the wireless headphone 93 to the intelligent shutter spectacles 61. The intelligent shutter spectacles 61 receive the audio signal from the wireless headphone 93 which transmits the audio signal to the intelligent shutter spectacles 61 through the cable. Then, the intelligent shutter spectacles 61 carry out the processing represented by the flowchart shown in FIG. 12 on the audio signal which has been received from the wireless headphone 93.

Thus, also in the case of the third embodiment, the intelligent shutter spectacles 61 are capable of generating a timing signal from the audio signal received from the wireless headphone 93 and carrying out shutter operations in accordance with the timing signal. As a result, it is possible to watch a 3-d stereoscopic video content by making use of the TV receiver 21 even if the TV receiver 21 does not have a function to output a timing signal.

In addition, by virtue of the third embodiment, it is possible to construct a 3-d stereoscopic video image watching system by making use of an existing wireless head phone system.

It is to be noted that the wireless headphone 93 can also be provided with a function to generate a timing signal. In addition, it is also possible to make use of a head phone stereo system for receiving an audio signal through a wire as a substitute for the wireless headphone 93.

### Chapter 4: Fourth Embodiment

### Configuration of the Fourth Embodiment

FIG. 14 is a diagram showing a typical configuration of a 3-d stereoscopic video image watching system 101 according to a fourth embodiment of the present invention.

In addition to the shutter spectacles 23, the timing-signal generation apparatus 22 and the TV receiver 21 which are employed in the first embodiment shown in the diagram of FIG. 2, the 3-d stereoscopic video image watching system 101 shown in the diagram of FIG. 14 also has a reproduction apparatus 111.

The reproduction apparatus 111 supplies 2-d video data to the TV receiver 21. As is obvious from the descriptions given earlier, the 2-d video data is data including left-eye and right-eye images which represent a 3-d stereoscopic video image. In addition, the reproduction apparatus 111 also supplies an audio signal associated with 2-d video images based on the 2-d video data as an audio signal conforming to the IEC60958 to the timing-signal generation apparatus 22 through the cable 31. Typical examples of the reproduction apparatus 111 are a Blu-ray (registered trademark) disc recorder functioning as a recording/reproduction apparatus and a PC (Personal Computer) serving as a recording/reproduction apparatus.

The timing-signal generation apparatus 22 connected by the cable 31 to a digital audio output terminal 21a of the reproduction apparatus 111 generates a timing signal from the audio signal received from the reproduction apparatus 111 through the cable 31 and transmits the timing signal to the shutter spectacles 23. It is to be noted that the digital audio output terminal 21a itself is not shown in the diagram of FIG. 14.

As described above, the timing-signal generation apparatus 22 can also be applied to a configuration in which the reproduction apparatus 111 for displaying 2-d video images on the TV receiver 21 external to the reproduction apparatus 111 does not have a terminal for outputting a timing signal.

In accordance with the first to fourth embodiments described above, it is possible to watch a 3-d stereoscopic video content even if the apparatus for displaying video images does not have a function to output a timing signal.

In the first to fourth embodiments described above, the frequency of the timing signal generated by the timing-signal generation section 43 is 60 Hz or 59.94 Hz, either of which is a frequency determined in advance to serve as a frequency of the vertical synchronization signal used for displaying 2-d video signals on the TV receiver 21. It is to be noted, however, that the timing-signal generation apparatus 22 or the intelligent shutter spectacles 61 can be made capable of selecting the value 60 Hz or 59.94 Hz as the frequency of the timing signal generated by the timing-signal generation section 43.

It is also worth noting that, in this specification, steps of each of the flowcharts described above can be carried out not only in a pre-prescribed order along the time axis, but also concurrently or individually. In other words, even though the steps can of course be carried out in the pre-prescribed order along the time axis, the steps are not necessarily carried out in the pre-prescribed order along the time axis. For example, the steps can also be carried out concurrently or individually with demanded timings on an as-invoked basis.

It is also to be noted that the technical term ‘system’ used in this specification implies the configuration of a confluence including a plurality of apparatus.

In addition, implementations of the present invention are by no means limited to the first to fourth embodiments described above. That is to say, the first to fourth embodiments described above can be changed to a variety of modified versions within a range which does not deviate from essentials of the present invention.

The present application contains subject matter related to that disclosed in Japanese Priority Patent Application JP 2009-221299 filed in the Japan Patent Office on Sep. 25, 2009, the entire content of which is hereby incorporated by reference.

What is claimed is:

1. A signal generation apparatus comprising:
bit-clock extraction means for receiving a digital audio signal output by an apparatus for displaying a two-dimensional video image used for sensing a three-dimensional stereoscopic video image on a screen determined in advance and for extracting a bit clock signal from said digital audio signal; and
timing-signal generation means for generating a timing signal having the same period as a vertical synchronization signal of said two-dimensional video image from said bit clock signal extracted by said bit-clock extraction means.

2. The signal generation apparatus according to claim 1, said signal generation apparatus further having bit clock frequency determination means for determining the frequency of said bit clock signal extracted by said bit-clock extraction means, wherein said timing-signal generation means divides a frequency determined by said bit clock frequency determination means as said frequency of said bit clock signal by a division number determined in advance on the basis of said frequency of said bit clock signal in order to generate said timing signal.

3. The signal generation apparatus according to claim 2, said signal generation apparatus further having:
operation means to be operated by the user; and
phase adjustment means for shifting the phase of said timing signal generated by said timing-signal generation means while the user is operating said operation means.

4. The signal generation apparatus according to claim 2 wherein said timing-signal generation means:
selectively determines said division number on the basis of a pre-stored relation between values of said division number and values of said frequency of said bit clock signal; and
divides a frequency determined by said bit clock frequency determination means as said frequency of said bit clock signal by said selectively determined division number in order to generate said timing signal.

5. The signal generation apparatus according to claim 2, said signal generation apparatus further having signal outputting means for outputting said timing signal, which has been generated by said timing-signal generation means, by radio communication.

6. The signal generation apparatus according to claim 2 wherein said audio signal is an audio signal conforming to the International Electrotechnical Commission 60958 standard.

7. Shutter spectacles comprising:
bit-clock extraction means for receiving a digital audio signal output by an apparatus for displaying a two-dimensional video image used for sensing a three-dimensional stereoscopic video image on a screen determined in advance and for extracting a bit clock signal from said digital audio signal;
timing-signal generation means for generating a timing signal having the same period as a vertical synchronization signal of said two-dimensional video image from said bit clock signal extracted by said bit-clock extraction means; and
shutter driving means for driving a shutter for a left eye and a shutter for a right eye on the basis of said timing signal generated by said timing-signal generation means.

8. The Shutter spectacles according to claim 7, said shutter spectacles further having:
operation means to be operated by the user; and
phase adjustment means for shifting the phase of said timing signal generated by said timing-signal generation means while the user is operating said operation means.

9. The Shutter spectacles according to claim 7 wherein said bit-clock extraction means is connected to said apparatus by a wire through which said apparatus outputs said digital audio signal to said bit-clock extraction means.

10. The Shutter spectacles according to claim 7 wherein said bit-clock extraction means receives said audio signal from said apparatus which outputs said digital audio signal to said bit-clock extraction means by way of a head phone stereo system.

11. Shutter spectacles comprising:
bit-clock extraction means for receiving a digital audio signal output by a display apparatus and for extracting a bit clock signal from said digital audio signal;
timing-signal generation means for generating a timing signal on the basis of said bit clock signal; and
shutter driving means for driving a shutter for a left eye and a shutter for a right eye on the basis of said timing signal.

12. The Shutter spectacles according to claim 11, said shutter spectacles further having:
operation means to be operated by the user; and
phase adjustment means for shifting the phase of said timing signal in accordance with said operation means.

13. A three-dimensional stereoscopic video image watching system comprising:
a display apparatus;
bit-clock extraction means for receiving a digital audio signal output by said display apparatus and for extracting a bit clock signal from said digital audio signal;
timing-signal generation means for generating a timing signal on the basis of said bit clock signal; and
shutter driving means for driving a shutter for a left eye and a shutter for a right eye on the basis of said timing signal.

14. The three-dimensional stereoscopic video image watching system according to claim 13, said three-dimensional stereoscopic video image watching system further having:
operation means to be operated by the user; and
phase adjustment means for shifting the phase of said timing signal in accordance with said operation means.

15. A signal generation apparatus comprising:
a bit-clock extraction section configured to receive a digital audio signal output by an apparatus for displaying a 2-d video image used for sensing a 3-d stereoscopic video image on a screen determined in advance and to extract a bit clock signal from said digital audio signal; and
a timing-signal generation section configured to generate a timing signal having the same period as a vertical synchronization signal of said 2-d video image from said bit clock signal extracted by said bit-clock extraction section.
